(19) United States
(12) Patent Application Publication
(10) Pub. No.: US 2006/0258282 A1
(43) Pub. Date: Nov. 16, 2006

(54) Ventilation device for the rear region of a motor vehicle

(75) Inventor: Thomas Heck, Mainz-Laubenheim (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/403,191

(22) Filed: Apr. 13, 2006

(30) Foreign Application Priority Data
Apr. 14, 2005 (DE) 10 2005 017 332.2

(51) Int. Cl. B60H 1/00; B60H 1/34; B60H 1/26

(52) U.S. Cl. 454/143; 454/152

(57) ABSTRACT

The invention relates to a ventilation device for a motor vehicle with an air guide, in the interior of which air is conveyed into the rear region of the passenger compartment of the motor vehicle, and with an air outlet element through which the air flows out into the rear region of the passenger compartment. According to the invention, the air outlet element can be adjusted in its height relative to the floor of the passenger compartment.

### CLAIM FOR PRIORITY

This application claims the benfit of priority to German Application No. 10 2005 017 332.2, filed in the German language on Apr. 14, 2005, the contents of which are hereby incorporated by reference.

### TEHCNICAL FIELD OF THE INVENTION

The invention relates to a ventilation device for a motor vehicle with an air guide, in the interior of which air is conveyed into the rear region of the passenger compartment of the motor vehicle, and with an air outlet element through which the air flows out into the rear region of the passenger compartment.

### BACKGROUND OF THE INVENTION

Ventilation outlets in motor vehicles are arranged, in each case in a fixed position, both in the region of the dashboard and in the rear region, i.e. in the region of the seats which are situated behind the driver's seat and front passenger seat. The outlet plane of the air is therefore defined in relation to the height of said outlet plane in the vehicle. Only the outlet angle can still be varied by adjusting slats or louvers, so that the region in which the air strikes against the body of the vehicle passengers can be adapted to their wishes and requirements.

In the case of the passengers sitting in front of the dashboard, a relatively large vertical region between head and lower upper body can already be covered by means of the adjustment of the angle, since the outlet plane of the ventilation outlets situated there is situated approximately centrally in front of the upper body of the passengers.

The matter becomes more difficult for the rear passengers. The air is generally conveyed into the rear region of the vehicle via a tunnel console close to the floor. It then emerges there from the tunnel console at a low height above the vehicle floor, i.e. the outlet plane of the rear air outlets is normally situated below the knees of the rear passengers. Accordingly, the air primarily flows around the lower legs of the rear passengers. An adjustment of the angle of the outflow direction of the air only brings a small improvement, since the knees absorb a large part of the air flow output upward, with the result that only a small amount of air reaches the upper body of the rear passengers. Under some circumstances, the head region is even not reached at all.

### SUMMARY OF THE INVENTION

The invention therefore proposes to design an air outlet element situated in the rear region in a manner such that it can be adjusted in its height relative to the tunnel console.

It is therefore possible to vary the height of the air outlet plane and also to have a sufficient quantity of air flowing around the upper body regions of the rear passengers when required. The disadvantage caused by the air guide close to the floor and outflow of air in the rear region is completely compensated for by the vertical adjustability.

The adjustment of the air outlet element preferably takes place between an initial height situated in the region of the vertical extent of the tunnel console and a final height situated in the region above the knees of the rear passengers. This corresponds to the essential region which, in order to reach the upper body, should have air flowing around it. If the outflow angle is additionally varied, the head region of the passengers can also easily be reached. The final height is not situated too far above the tunnel console, since the covering of a large vertical region would be associated with a projecting adjusting mechanism, which is avoided for ergonomic reasons.

In a preferred embodiment of the invention, a tubular air supply element is arranged in the tunnel console, which air supply element, at an end facing the rear passengers, is connected to the air outlet element or is formed integrally therewith. This air supply element is in turn situated in an outer tube, which is likewise arranged in the tunnel console and conducts air, and is mounted in said outer tube in a longitudinally displaceable manner. In this case, the length of the air supply element determines the final height which can be reached. The cross section of the two tubes can be configured as desired, for example can be circular or elliptical or else polygonal. By means of the air supply element and the outer tube being arranged such that they are situated one inside the other, the functions of the air guide and of the mechanical length and therefore vertical adjustment can be linked with one another in a simple manner.

In one aspect of the preferred embodiment, a vertical adjustment of the air outlet element can take place in various ways. In one embodiment, it is therefore provided that the adjustment takes place by the air supply element being pulled manually out of the outer tube. As an alternative, it is proposed for the air supply element to be pushed out of the outer tube by means of an electric motor. In both cases, this permits an infinitely variable setting of the height and therefore of the air outlet plane.

Instead of the infinitely variable vertical adjustment, this may also take place stepwise by latching elements, such as lugs, knobs or beads, or spring elements being fixed on the outer circumference of the air supply element and engaging in latching grooves, channels or openings and thereby holding the air supply element at a predetermined intermediate height. In this case, the latching grooves, channels or openings are placed in the outer tube in a manner spaced apart from one another along the longitudinal extent of said outer tube.

In a further embodiment, the air supply element is connected to a negative pressure unit. A membrane which is oriented approximately horizontally with respect to the vehicle floor and which separates two chambers situated one above the other from each other is situated in the negative pressure unit, which is also called a vacuum unit, with the membrane being set into a downward or upward movement by the build-up and dissipation of negative pressure in one of the chambers, depending on whether the negative pressure is produced in the upper or the lower chamber. The upward and downward movement is transmitted directly to the air supply element. The negative pressure can be produced, for example, by means of a valve-controlled connection of the negative pressure unit to the air guides, which are under negative pressure, of the driving tract of the motor. Depending on whether the negative pressure dissipation and build-up takes place continuously or stepwise, an infinitely variable or a stepwise vertical adjustment can be realized in this embodiment.

However, in the case of all of the previously mentioned embodiments for the vertical adjustment of the air supply element and therefore of the air outlet element, a two-stage adjustment is also conceivable, in which the air outlet element is merely moved up and down between the initial height and the final height. The refinement of the ventilation device with a push-push spring mechanism also leads to a two-stage vertical adjustment. In this case, the air supply element is released mechanically from its anchoring or latching by a first push actuation, and the air outlet element is conveyed by means of spring force from its initial height into the final height. The air outlet element is pressed back again into the initial height by a second push actuation and the air supply element is again anchored or latched in place there.

### BRIEF DESCRIPTION OF THE DRAWINGS

The invention is explained in more detail below with reference to the exemplary embodiments and the drawings, in which:

FIG. 1 shows a vertically adjustable ventilation device for the rear region.

FIG. 2 shows the ventilation device from FIG. 1 in the initial height.

FIG. 3 shows the ventilation device from FIG. 1 in the final height.

FIG. 4 shows an air guiding element which is adjustable in three stages, in an outer tube.

### DETAILED DESCRIPTION OF THE INVENTION

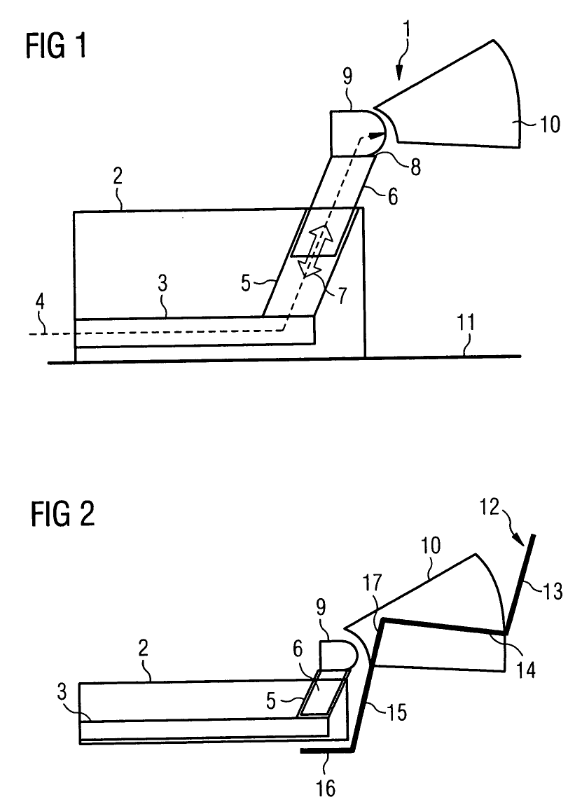

FIG. 1 shows a rear region 1 which belongs to the passenger compartment of a motor vehicle and in which a tunnel console 2 ends. An air pipe 3 through which air 4 is conveyed into the vicinity of the rear region 1 runs in the interior of the tunnel console 2. An outer tube 5 is connected to the air pipe 3. A tubular air supply element 6 is mounted displaceably in the direction 7 of its longitudinal extent in the outer tube 5. An air outlet element 9 in the form of an outlet nozzle through which the air 4 flows out in the direction of the rear region 1 is fitted at the upper end 8 of the air supply element 8. Accordingly, a longitudinal displacement of the air supply element 6 in the direction 7 leads to a vertical adjustment of the air outlet element 9 relative to the floor 11 of the rear region 1 and therefore of the passenger compartment. The overall arrangement of air pipe 3, outer tube 5 and air supply element 6 therefore forms an air guide with which the air is guided as far as the air outlet element 9. This air guide and the air outlet element 9 together produce the ventilation device for the rear region 1. After flowing out of the air outlet element 9, the air 4 forms an air cone 10 which reaches part of the rear region 1.

FIG. 2 shows the ventilation device from FIG. 1 in the initial height, i.e. the air supply element 6 has been retracted as far as possible into the outer tube 5, as a result of which the air outlet element 9 is situated at its lowest height. A rear passenger 12 (indicated diagrammatically) sits laterally on the left in front of the tunnel console 2. The extents of his upper body 13, his thighs 14, his lower legs 15 and his feet 16 are illustrated. In the initial height, the air cone 10 emerging from the air outlet element 9 above all flows around the knees 17 of the rear passenger 12 and his thighs 14. By contrast, no air reaches the upper body 13.

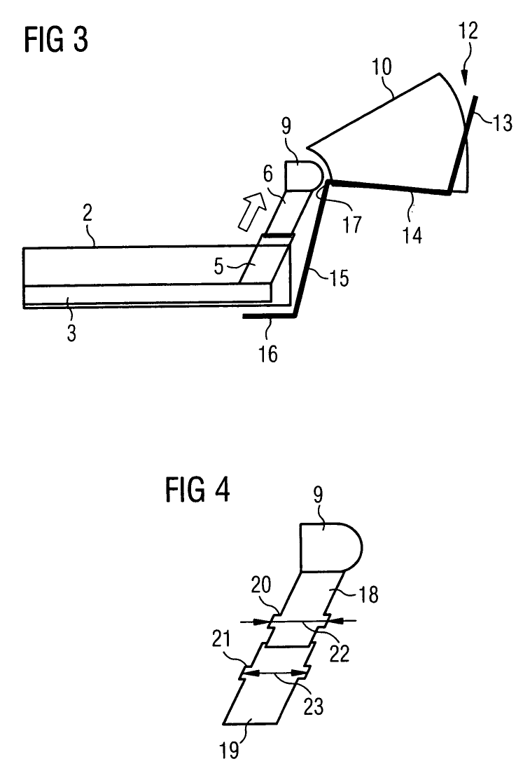

In order also to have air flowing around the upper body 13, the air outlet element 9 is adjusted in its height. In FIG. 3, it is being brought into its final height by the air supply element 6 having been completely pushed or pulled out of the outer tube 5. The final height of the air outlet element 9 is situated precisely at the distance above the knees 17 of the rear passenger 12 that enables the air cone 10 to reach the upper body 13 without obstruction.

FIG. 4 illustrates a particular refinement of the ventilation device from FIGS. 1 to 3. An air supply element 18, an outer tube 19 and the air outlet element 9 can be seen. A bead 20 formed from elastic material leads around the outer circumference of the air supply element 18. A groove 21 encircling in the interior has been made as counterpart in the outer tube 19. In this case, the outside diameter 22 of the air supply element 18 is larger at the location of the bead 20 than the inside diameter 23 of the outer tube 19 at the location of the groove 21. If the air supply element 18 is pushed into the outer tube 19, then the elastic bead 20 presses into the groove 21. The air supply element 18 can only be moved out of this position again by the application of a relatively large force. The air supply element 18 or the air outlet element 9 fastened to its upper end can therefore take up a total of three vertical steps: the initial height with the air supply element 18 completely pushed in, the intermediate height defined by the height of the groove in the outer tube 19, and the final height with the air supply element 18 completely extended.

What is claimed is:

1. A ventilation device for a motor vehicle, comprising:
an air guide, in an interior of which air is conveyed into a rear region of a passenger compartment of the motor vehicle; and
an air outlet element through which the air flows out into the rear region of the passenger compartment, wherein the air outlet element is configured to be adjusted in height relative to a floor of the passenger compartment.

2. The ventilation device as claimed in claim 1, wherein adjustment of the air outlet element takes place between an initial height situated in a region of a vertical extent of the air guide and a final height situated in a region above knees of a rear passenger.

3. The ventilation device as claimed in claim 2, wherein the air guide comprises a tubular air supply element, which air supply element, at an end facing the rear passenger, is connected to the air outlet element or is formed integrally therewith, and the air supply element is mounted in a longitudinally displaceable manner in an outer tube.

4. The ventilation device as claimed in claim 3, wherein the adjustment of the air outlet element takes place by the air supply element being pulled manually out of the outer tube.

5. The ventilation device as claimed in claim 3, wherein the adjustment of the air outlet element takes place by the air supply element being pushed out of the outer tube by an electric motor.

6. The ventilation device as claimed in claim 3, wherein the adjustment of the air outlet element takes place stepwise, with the steps being defined by latching or spring elements arranged on the outer circumference of the air supply element latching into latching grooves or openings of the outer tube.

7. The ventilation device as claimed in claim 3, wherein the air supply element is connected to a negative pressure unit, with a downward or upward movement of a membrane situated in the interior of the negative pressure unit, which downward or upward movement is produced by buildup or dissipation of negative pressure, being transmitted to the air supply element.

8. The ventilation device as claimed in claim 3, wherein the adjustment of the air outlet element takes place in two stages between an initial height and a final height.

9. The ventilation device as claimed in claim 3, wherein the air supply element is provided with a push-push spring mechanism, the air supply element being mechanically released by a first push actuation and the air outlet element being conveyed by spring force from an initial height into a final height, and the air outlet element being pushed back again into the initial height by a second push actuation and the air supply element being latched in place there.
